(19) United States
(12) Patent Application Publication
(10) Pub. No.: US 2010/0306834 A1
(43) Pub. Date: Dec. 2, 2010

(54) SYSTEMS AND METHODS FOR MANAGING SECURITY AND/OR PRIVACY SETTINGS

(75) Inventors: Tyrone W.A. Grandison, San Jose, CA (US); Kun Liu, San Jose, CA (US); Eugene Michael Maximilien, San Jose, CA (US); Evimaria Terzi, San Jose, CA (US)

Correspondence Address: Brian K. Lambert, International Business Machines Corporation, Almaden Research Center 650 Harry Road, San Jose, CA, 95120, US

(73) Assignee: INTERNATIONAL BUSINESS MACHINES CORPORATION, Armonk, NY (US)

(21) Appl. No.: 12/468,738

(22) Filed: May 19, 2009

(51) Int. Cl. H04L 29/04; G06F 15/16; G06F 21/00

(52) U.S. Cl. 726/7; 709/229; 709/205

(57) ABSTRACT

Systems and methods for managing security and/or privacy settings are described. In one embodiment, the method may include communicably coupling a first client to a second client. The method may further include propagating a portion of a plurality of security and/or privacy settings for the first client from the first client to the second client. The method may also include, upon receiving at the second client the portion of the plurality of security and/or privacy settings for the first client, incorporating the received portion of the plurality of security and/or privacy settings for the first client into a plurality of security and/or privacy settings for the second client.

### FIELD OF THE INVENTION

Embodiments of the disclosure relate generally to the field of data processing systems. For example, embodiments of the disclosure relate to systems and methods for managing security and/or privacy settings.

### BACKGROUND

In some computing applications, such as web applications and services, a significant amount of personal data is exposed to others. For example, in regards to social networking sites, the site requests personal information from the user, including name, profession, phone number, address, birthday, friends, coworkers, employer, high school attended, etc. Therefore, a user is given some discretion in configuring his/her privacy and security settings in order to determine how much of and at what breadth the personal information may be shared with others.

In determining the appropriate privacy and security settings, a user may be given a variety of choices. For example, some sites ask multiple pages of questions to the user in attempting to determine the appropriate settings. Answering the questions may become a tedious and time intensive task for the user. As a result, the user may forego configuring his/her preferred security and privacy settings.

### SUMMARY

Methods for managing security and/or privacy settings are disclosed. In one embodiment, the method includes communicably coupling a first client to a second client. The method also includes propagating a portion of a plurality of security and/or privacy settings for the first client from the first client to the second client. The method further includes, upon receiving at the second client the portion of the plurality of security and/or privacy settings for the first client, incorporating the received portion of the plurality of security and/or privacy settings for the first client into a plurality of security and/or privacy settings for the second client.

These illustrative embodiments are mentioned not to limit or define the invention, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 illustrates an example social graph of a social network for a user.

FIG. 2 is a social networking graph of a person having a user profile on a first social networking site and a user profile on a second social networking site.

FIG. 3 is a flow chart of an example method for propagating privacy settings between social networks by the console.

FIG. 4 illustrates an example computer architecture for implementing a computing of privacy settings and/or a privacy environment.

### DETAILED DESCRIPTION OF PREFERRED EMBODIMENTS

Embodiments of the disclosure relate generally to the field of data processing systems. For example, embodiments of the disclosure relate to systems and methods for managing security and/or privacy settings. Throughout the description, for the purposes of explanation, numerous specific details are set forth in order to provide a thorough understanding of the present disclosure. It will be apparent, however, to one skilled in the art that the present disclosure may be practiced without some of these specific details. In other instances, well-known structures and devices are shown in block diagram form to avoid obscuring the underlying principles of the present disclosure.

In managing privacy and/or security settings, the system uses others' privacy and/or security settings in order to configure a user's privacy and/or security settings. Hence, settings from other users are propagated and compared in order to automatically create a preferred configuration of settings for the user. Automatic creation of privacy and/or security settings may occur in various atmospheres between clients. For example, creation may occur between computer systems using security software, internet browsers of various computers, multiple internet browsers on one computer, user profiles in a social networking site, user profiles among a plurality of social networking sites, and shopper profiles among one or more internet shopping sites.

For purposes of explanation, embodiments are described in reference to user profiles among one or more social networking sites. The below description should not be limiting, as it will be apparent to one skilled in the art implementation in a different atmosphere, including those listed above.

### Social Networks

Social applications/networks allow people to create connections to others. A user creates a profile and then connects to other users via his/her profile. For example, a first user may send a friend request to a second user who he/she recognizes. If the request is accepted, the second user becomes an identified friend with the first user. The totality of connections for one user's profile creates a graph of human relationships for the user.

The social network platform may be used as a platform operating environment by users, allowing almost instantaneous communication between friends. For example, the platform may allow friends to share programs, pass instant messages, or view special portions of the other friends' profiles, while allowing the user to perform standard tasks such as playing games (offline or online), editing documents, or sending emails. The platform may also allow information from other sources, including, for example, news feeds, easy access shopping, banking, etc. As a result of the multitude of sources providing information, mashups are created for users.

A mashup is defined as a web application that combines data from more than one source into an integrated tool. Many mashups may be integrated into a social networking platform. Mashups also require some amount of user information. Therefore, whether a mashup has access to a user's information stored in the user profile is determined by the user's privacy and/or security settings.

### Privacy and/or Security Settings

In one embodiment, portions of a social network to be protected through privacy and/or security settings may be defined in six broad categories: user profile, user searches, feeds (e.g., news), messages and friend requests, applications, and external websites. Privacy settings for a user profile control what subset of profile information is accessible by whom. For example, friends have full access, but strangers have restricted access to a user profile. Privacy setting for Search control who can find a user's profile and how much of the profile is available during a search.

Privacy settings for Feed control what information may be sent to a user in a feed. For example, the settings may control what type of news stories may be sent to a user via a news feed. Privacy settings for message and friend requests control what part of a user profile is visible when the user is being sent a message or friend request. Privacy settings for an Application category controls settings for applications connected to a user profile. For example, the settings may determine if an application is allowed to receive the user's activity information with the social networking site. Privacy settings for an External website category control information that may be sent to a user by an external website. For example, the settings may control if an airline's website may forward information regarding a last minute flight deal.

Hence, the privacy and/or security settings may be used to control portions of user materials or accesses. For example, the privacy settings for the six broad categories may be used to limit access to a user by external websites and limit access to programs or applications by a user.

### Embodiment for Propagating Privacy and/or Security Settings

Alternative to manually setting all components of privacy settings so that the user is in complete control and knowledge of the user's privacy settings, two types of privacy protections exist in current privacy models: (1) an individual's privacy may be protected by hiding the individual in a large collection of other individuals and (2) an individual's privacy may be protected by having the individual hide behind a trusted agent. For the second concept, the trusted agent executes tasks on the individual's behalf without divulging information about the individual.

In order to create a collective, fictitious individuals may need to be added or real individuals deleted, including adding or deleting relationships. Thus, an individual would hide in a severely edited version of the social graph. One problem with such an approach is that the utility of the network is hindered or may not be preserved. For example, the central application would be required to remember all edits made to the social graph in order to hide an individual in a collective. In using a trusted agent, it is difficult and may be costly to find an agent that can be trusted or that will only perform tasks that have been requested. Therefore, one embodiment of the present invention eliminates the need for a collective or trusted agent by automating the task of setting user privacy settings.

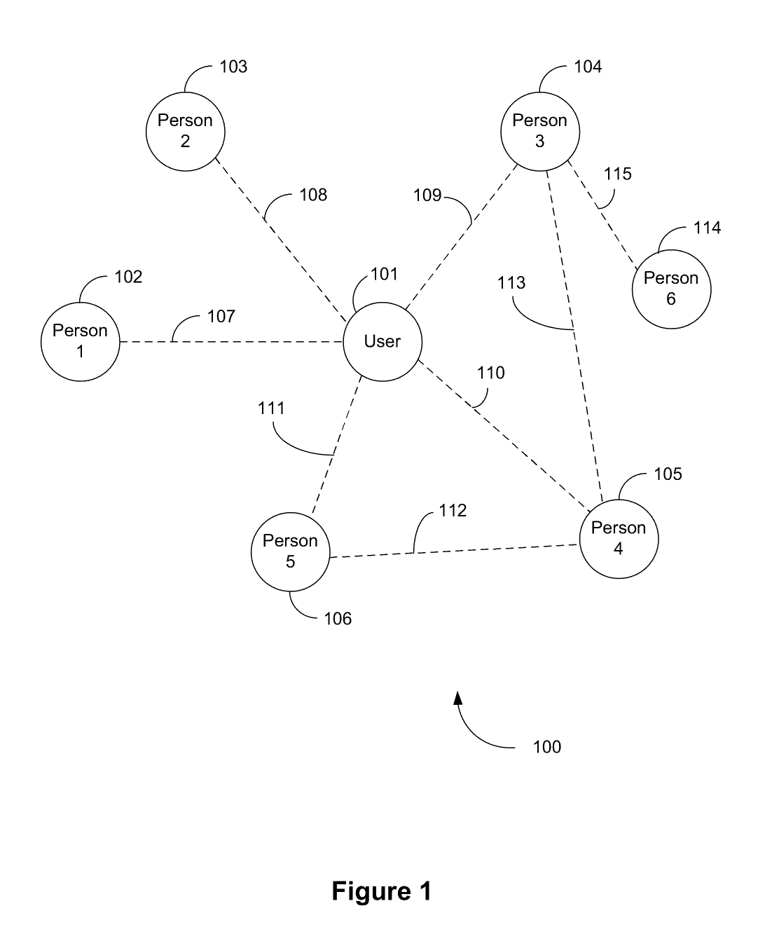

FIG. 1 illustrates an example social graph 100 of a social network for user 101. The social graph 100 illustrates that the user's 101 social network includes person 1 102, person 3 103, person 4 104, and person 5 105 directly connected to user 101 (connections 107-111, respectively). For example, the persons may be work colleagues, friends, or business contacts, or a mixture, who have accepted user 101 as a contact and for which user 101 has accepted as a contact. Relationships 112 and 113 show that Person 4 105 and Person 5 106 are contacts with each other and Person 4 105 and Person 3 104 are contacts with each other. Person 6 114 is a contact with Person 3 104 (relationship 115), but Person 6 114 is not a contact with User 101. Through graphing each user's social graph and linking them together, a graph of the complete social network can be created.

Each of the persons/user in Social Graph 100 are considered a node. In one embodiment, each node has its own privacy settings. The privacy settings for an individual node creates a privacy environment for the node. Referring to User 101 in one example, User 101 privacy environment is defined as Eᵤₛₑᵣ={e₁, e₂, . . . , eₘ} wherein eᵢ is an indicator to define a privacy environment E and m is the number of indicators in a user's 101 social network that defines the privacy environment Eᵤₛₑᵣ. In one embodiment, an indicator e is a tuple of the form {entity, operator, action, artifact}. Entity refers to an object in the social network. Example objects include, but are not limited to, person, network, group, action, application, and external website(s). Operator refers to ability or modality of the entity. Example operators include, but are not limited to, can, cannot, and can in limited form. Interpretation of an operator is dependent on the context of use and/or the social application or network. Action refers to atomic executable tasks in the social network. Artifact refers to target objects or data for the atomic executable tasks. The syntax and semantics of the portions of the indicator may be dependent on the social network being modeled. For example, indicator eᵣ={X, “can”, Y, Z}, which is “Entity X can perform action Y on artifact Z.” Indicators may be interdependent on one another. But for illustration purposes, atomic indicators will be offered as examples.

In one embodiment, privacy settings configure the operators in relation to the entity, action, and artifact. Therefore, the privacy settings may be used to determine that for indicator {X, “ ”, Y, Z}, entity X is not allowed to perform action Y at any time. Therefore, the privacy settings would set the indicator as {X, “cannot”, Y, Z}.

In one embodiment, when a user engages in new activity external to his/her current experience, then the user may leverage the privacy settings of persons in his network that are involved with such activity. For example, if user 101 wishes to install a new application, the privacy settings of the persons 1-5 (107-111), if they have installed the new application, may be used to set user's 101 privacy settings regarding the new application. Thus, the user 101 will have a reference as to whether the application may be trusted.

In one embodiment, if a user wishes to install an application and the user is connected to only one other person in his social network that has previously installed the application, then the privacy settings from the person regarding the application would be copied to the user. For example, with the entity as the person, “install” as the action, and the artifact as the application, the indicator for the person may be {person, “can”, install, application}. Thus, the user would receive the indicator as part of his/her privacy environment as {user, “can”, install, application}.

If two or more persons connected to the user include a relevant indicator (e.g., all indicators include the artifact “application” in the previous example), then the totality of relevant indicators may be used to determine an indicator for the user. In one embodiment, the indicator created for the user includes two properties. The first property is that the user indicator is conflict-free with the relevant indicators. The second property is that the user indicator is the most restrictive as compared to all of the relevant indicators.

In reference to conflicts between indicators, the indicators share the same entity, action, and artifact, but the operators between the indicators conflict with one another (e.g., “can” versus “cannot”). Conflict-free refers to that all conflicts have been resolved when determining the user indicator. In one embodiment, resolving conflicts includes finding the most relevant, restrictive operator in a conflict, discarding all other operators. For example, if three relevant indicators are {A, “can”, B, C}, {A, “can in limited form”, B, C}, and {A, “cannot”, B, C}, the most restrictive operator is “cannot.” Thus, a conflict-free indicator would be {A, “cannot”, B, C}. As shown, the conflict-free indicator is also the most restrictive, hence satisfying the two properties.

In one embodiment, a user's privacy environment changes with respect to any changes in the user's social network. For example, if a person is added to a user's social network, then the person's indicators may be used to update the user's indicators. In another embodiment, certain persons connected to a user may be trusted more than other persons. For example, persons who have been connected to the user for longer periods of time, whose profiles are older, and/or who have been tabbed as trusted by other users may have their indicators given more weight as compared to other persons. For example, user 101 may set person 1 102 as the most trusted person in the network 100. Therefore, person 1's indicators may be relied on above other less trusted indicators, even if the operator of the less trusted indicators is more restrictive.

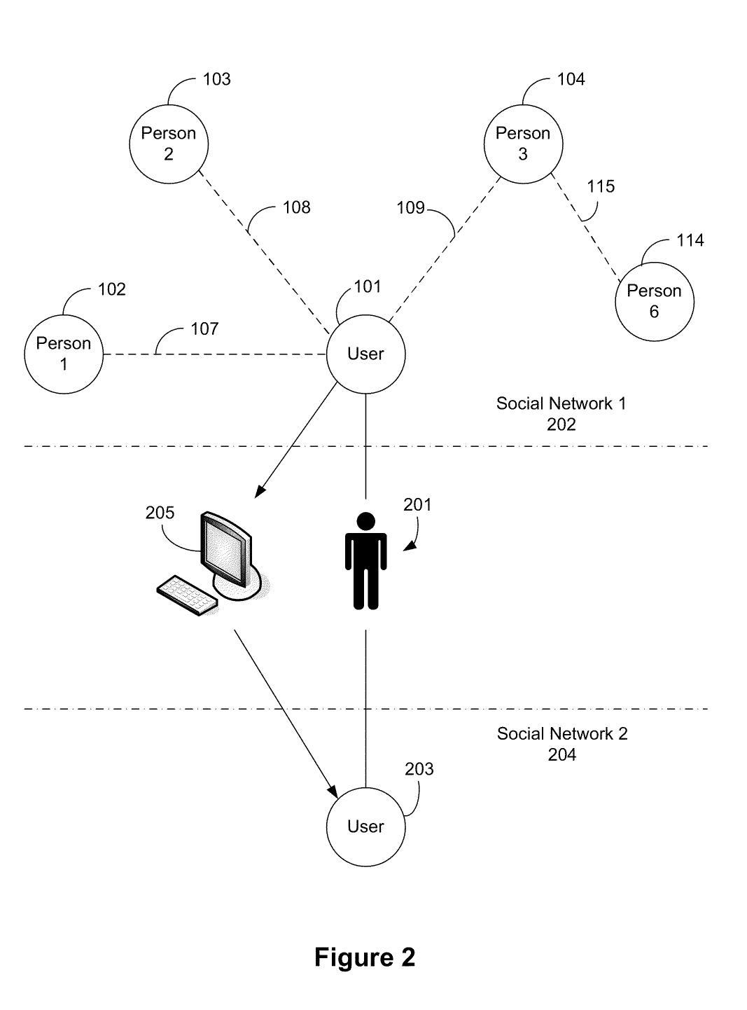

In one embodiment, a person having a user profile on two separate social networking sites may use privacy settings from one site to set the privacy settings on another site. Thus, indicators would be translated from one site to another. FIG. 2 illustrates a person 201 having a user profile 101 on a first social networking site 202 and a user profile 203 on a second social networking site 204. Most social networking sites do not speak to one another. Therefore, in one embodiment, a user console 205 would be used for inter-social-network creation of a privacy environment.

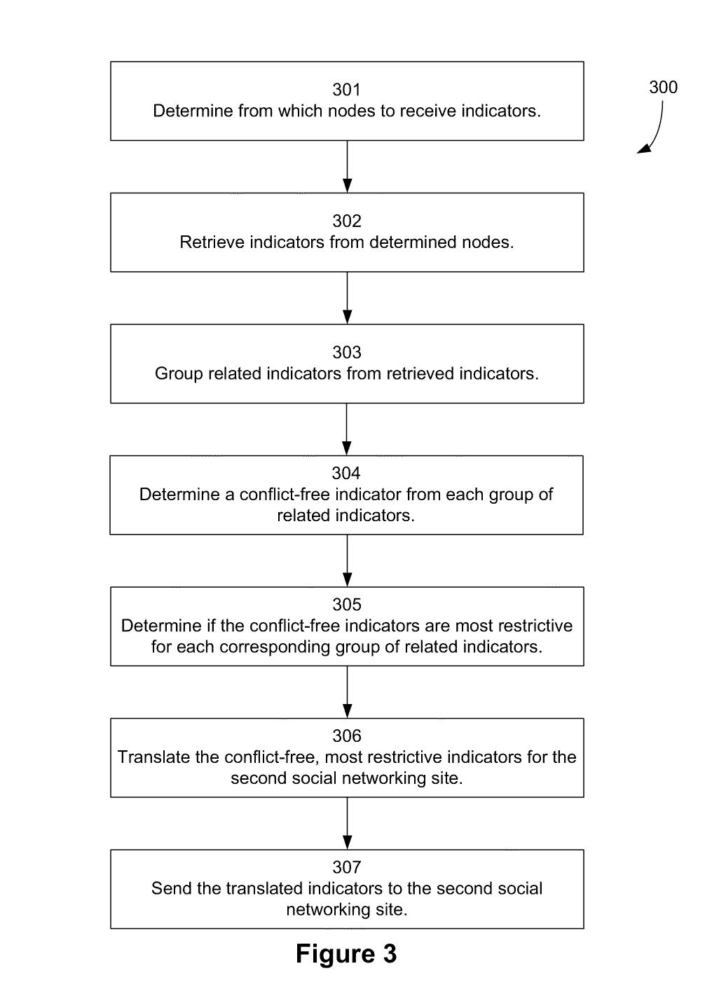

FIG. 3 is a flow chart of an example method 300 for propagating privacy setting between social networks by the console 205. Beginning at 301, the console 205 determines from which node to receive indicators. For example, if the user 203 in FIG. 2 needs privacy settings for an application that exists on both social networks 202 and 204, then it is determined which persons connected to user node 101 have an indicator for the application. In one embodiment, the indicator is pulled from the user node 101 indicators, wherein the privacy settings may have already been determined using others' indicators. Thus, to create a privacy environment, the console 205 may determine from which nodes to receive all indicators or those nodes in order to compute a privacy environment. If an indicator does not relate to the social networking site 204 (e.g., a website that is accessed on Networking site 202 cannot be accessed on Networking site 204), then the console 205 may ignore such indicator when received.

Proceeding to 302, the console 205 retrieves the indicators from the determined nodes. As previously stated, all indicators may be retrieved from each node. In another embodiment, only indicators of interest may be retrieved. In yet another embodiment, the system may continually update privacy settings, therefore, updated or new indicators are periodically retrieved in order to update user 203's privacy environment.

Proceeding to 303, the console 205 groups related indicators from the retrieved indicators. For example, if all of the indicators are pulled for each determined node, then the console 205 may determine which indicators are related to the same or similar entity, action, and artifact. Proceeding to 304, the console 205 determines from each group of related indicators a conflict-free indicator. The collection of conflict-free indicators are to be used for the user node's 203 privacy environment.

Proceeding to 305, the console 205 determines for each conflict-free indicator if the indicator is the most restrictive for its group of related indicators. If a conflict-free indicator is not most restrictive, then the console 205 may change the indicator a redetermine the indicator. Alternatively, the console 205 may ignore the indicator and not include in determining user node's 203 privacy environment. Proceeding to 306, the console 205 translates the conflict-free, most restrictive indicators for the second social networking site. For example, “can in limited form” may be an operator that is interpreted differently by two different social networking sites. In another example, one entity in a first social networking site may be of a different name on a second social networking site. Therefore, the console 205 attempts to map the indicators to the format relevant to the second social networking site 204. Upon translating the indicators, the console 205 sends the indicators to the user node 203 in the second social networking site 204 in 307. The indicators are then set for the user 203 to create its privacy environment for its social network.

For some social networking sites, pages of user directed questions sets the privacy environment. Some social networking sites have groups of filters and user controls to set the privacy environment. Therefore, in one embodiment, answers to the questions, filters, or user settings may be pulled. As such, indicators are created from the pulled information. Furthermore, translating indicators may include determining the answers to the user questions or setting filters and user settings for a second social networking site. Therefore, the console 205 (or client on the social networking site) may set the questions or user controls in order to create a user node's privacy settings.

While the above method is illustrated between two social networking sites, multiple social networks may exist or a user on the same social networking site. Therefore, a user node may have different privacy settings depending on the social network. Hence, the method may also be used to propagate privacy settings among social networks on the same social networking site.

In one embodiment, privacy settings may change depending on an event. For example, if an event A occurs, then an indicator may become less restrictive (operator to change from “cannot” to “can in limited form”). Therefore, indicators may include subsets of information to account for dependencies. For example, an entity may or may not have a trusted status by the social networking site. Therefore, if an entity is not trusted, then operators regarding the entity may be restrictive (e.g., {Entity A[not trusted], “cannot”, B, C}). Upon becoming trusted, indicators may be updated to take such into account (e.g., {A[trusted], “can”, B, C}). For example, a trusted person may be able to search for a user's full profile, while an untrusted person may not.

A user's privacy environment may also depend on a user's activity in the social network. For example, a user who divulges more information engages in riskier activity then someone who is not an active user in a social network. Therefore, use may be a subset of information in order to determine what a user's privacy environment should be. In one embodiment, a privacy risk score is used to make a user's privacy settings more or less restrictive. Below is described an embodiment for computing a user's privacy risk score.

### Exemplary Embodiment for Computing a User Privacy Risk Score

For a social-network user j, a privacy risk score may be computed as a summation of the privacy risks caused to j by each one of his profile items. The contribution of each profile item in the total privacy risk depends on the sensitivity of the item and the visibility it gets due to j's privacy settings and j's position in the network. In one embodiment, all N users specify their privacy settings for the same n profile items. These settings are stored in an n×N response matrix R. The profile setting of user j for item i, R(i, j), is an integer value that determines how willing j is to disclose information about i; the higher the value the more willing j is to disclose information about item i.

In general, large values in R imply higher visibility. On the other hand, small values in the privacy settings of an item are an indication of high sensitivity; it is the highly-sensitive items that most people try to protect. Therefore, the privacy settings of users for their profile items, stored in the response matrix R have valuable information about users' privacy behavior. Hence, a first embodiment uses the information to compute the privacy risk of users by employing notions that the position of every user in the social network also affects his privacy risk and the visibility setting of the profile items is enhanced (or silenced) depending on the user's role in the network. In privacy-risk computation, the social-network structure and use models and algorithms from information-propagation and viral marketing studies are taken into account.

In one embodiment, a social-network G that consists of N nodes, every node j in {1, . . . , N} being associated with a user of the network. Users are connected through links that correspond to the edges of G. In principle, the links are unweighted and undirected. However, for generality, G is directed and undirected networks are converted into directed ones by adding two directed edges (j->j′) and (j′->j) for every input undirected edge (j, j′). Every user has a profile consisting of n profile items. For each profile item, users set a privacy level that determines their willingness to disclose information associated with this item. The privacy levels picked by all N users for the n profile items are stored in an n×N response matrix R. The rows of R correspond to profile items and the columns correspond to users.

R(i, j) refers to the entry in the i-th row and j-th column of R; R(i, j) refers to the privacy setting of user j for item i. If the entries of the response matrix R are restricted to take values in {0, 1}, R is a dichotomous response matrix. Else, if entries in R take any non-negative integer values in {0, 1, . . . , l}, matrix R is a polytomous response matrix. In a dichotomous response matrix R, R(i, j)=1 means that user j has made the information associated with profile item i publicly available. If user j has kept information related to item i private, then R(i, j)=0. The interpretation of values appearing in polytomous response matrices is similar: R(i, j)=0 means that user j keeps profile item i private; R(i, j)=1 means that j discloses information regarding item i only to his immediate friends. In general, R(i, j)=k (with k within {0, 1, . . . , l}) means that j discloses information related to item i to users that are at most k links away in G. In general, R(i, j)_R(i′, j) means that j has more conservative privacy settings for item i′ than item i. The i-th row of R, denoted by Ri, represents the settings of all users for profile item i. Similarly, the j-th column of R, denoted by Rj, represents the profile settings of user j.

Users' settings for different profile items may often be considered random variables described by a probability distribution. In such cases, the observed response matrix R is a sample of responses that follow this probability distribution. For dichotomous response matrices, P(i,j) denotes the probability that user j selects R(i, j)=1. That is, P(i,j)=Prob_R(i, j)=1. In the polytomous case, P(i,j,k) denotes the probability that user j sets R(i,j)=k. That is, P(i,j,k)=Prob_R(i, j)=k.

### Privacy Risk in Dichotomous Settings

The privacy risk of a user is a score that measures the protection of his privacy. The higher the privacy risk of a user, the higher the threat to his privacy. The privacy risk of a user depends on the privacy level he picks for his profile items. The basic premises of the definition of privacy risk are the following:

The more sensitive information a user reveals, the higher his privacy risk.

The more people know some piece of information about a user, the higher his privacy risk.

The following two examples illustrate these two premises.

### Example 1

Assume user j and two profile items, i={mobile-phone number} and i′={hobbies}. R(i, j)=1 is a much more risky setting for j than R(i′, j)=1; even if a large group of people knows j's hobbies this cannot be as an intrusive scenario as the one where the same set of people knows j's mobile-phone number.

### Example 2

Assume again user j and let i={mobilephone number} be a single profile item. Naturally, setting R(i, j)=1 is a more risky behavior than setting R(i, j)=0; making j's mobile phone publicly available increases j's privacy risk.

In one embodiment, the privacy risk of user j is defined to be a monotonically increasing function of two parameters: the sensitivity of the profile items and the visibility these items receive. Sensitivity of a profile item: Examples 1 and 2 illustrate that the sensitivity of an item depends on the item itself. Therefore, sensitivity of an item is defined as follows.

Definition 1. The sensitivity of item i in {1, . . . , n} is denoted by βi and depends on the nature of the item i.

Some profile items are, by nature, more sensitive than others. In Example 1, the {mobile-phone number} is considered more sensitive than {hobbies} for the same privacy level. Visibility of a profile item: The visibility of a profile item i due to j captures how known j's value for i becomes in the network; the more it spreads, the higher the item's visibility. Visibility, denoted by V(i, j), depends on the value R(i, j), as well as on the particular user j and his position in the social network G. The simplest possible definition of visibility is V(i, j)=I(R(i,j)=1), where I(condition) is an indicator variable that becomes 1 when “condition” is true. This is the observed visibility for item i and user j. In general, one can assume that R is a sample from a probability distribution over all possible response matrices. Then, the visibility is computed based on this assumption.

Definition 2. If P(i,j)=Prob_R(i, j)=1, then the visibility is V(i, j)=P(i,j)×1+(1−P(i,j))×0=P(i,j).
Probability P(i,j) depends both on the item i and the user j. The observed visibility is an instance of visibility where P(i,j)=I(R(i,j)=1). Privacy risk of a user: The privacy risk of individual j due to item i, denoted by Pr(i, j), can be any combination of sensitivity and visibility. That is, Pr(i, j)=βi N V(i, j). Operator N is used to represent any arbitrary combination function that respects that Pr(i, j) is monotonically increasing with both sensitivity and visibility.

In order to evaluate the overall privacy risk of user j, denoted by Pr(j), the privacy risk of j can be combined due to different items. Again, any combination function can be employed to combine the per-item privacy risks. In one embodiment, the privacy risk of individual j is computed as follows: Pr(j)=Summation from i=1 to n of Pr(i, j)=Summation from i=1 to n of βi×V(i, j)=Summation from i=1 to n of βi×P(i,j). Again, the observed privacy risk is the one where V(i, j) is replaced by the observed visibility.

### Naive Computation of Privacy Risks in Dichotomous Settings

One embodiment of computing the privacy risk score is the Naïve Computation of Privacy Risks. Naive computation of sensitivity: The sensitivity of item i, βi, intuitively captures how difficult it is for users to make information related to the i-th profile item publicly available. If |Ri| denotes the number of users that set R(i, j)=1, then for the Naive computation of sensitivity, the proportion of users that are reluctant to disclose item i is computed. That is, βi=(N−|Ri|/N. The sensitivity, as computed in the equation takes values in [0, 1]; the higher the value of βi, the more sensitive item i. Naive computation of visibility: The computation of visibility (see Definition 2) requires an estimate of the probability P(i,j)=Prob_R(i, j)=1. Assuming independence between items and individuals, P(i,j) is computed to be the product of the probability of a 1 in row Ri times the probability of a 1 in column Rj. That is, if |R̂j| is the number of items for which j sets R(i,j)=1, then P(i,j)=|Ri|/N×|Rj|/n=(1−βi)×|Rj|/n. Probability P(i,j) is higher for less sensitive items and for users that have the tendency to disclose many of their profile items. The privacy-risk score computed in this way is the Pr Naive score.

### IRT-Based Computation of Privacy Risk in Dichotomous Settings

Another embodiment of computing a privacy risk score is a privacy risk of users using concepts from Item-Response Theory (IRT). In one embodiment, the two-parameter IRT model may be used. In this model, every examinee j is characterized by his ability level θj, θj within (−1,1). Every question qi is characterized by a pair of parameters ξi=(αi, βi). Parameter βi, βi within (−1,1), represents the difficulty of qi. Parameter αi, αi within (−1,1), quantifies the discrimination ability of qi. The basic random variable of the model is the response of examinee j to a particular question qi. If this response is marked as either “correct” or “wrong” (dichotomous response), then in the two-parameter model the probability that j answers correctly is given by P(i,j)=1/(1+ê(−αi(θj−βi))). Thus, P(i,j) is a function of parameters θj and ξi=(αi, βi). For a given question qi with parameters ξi=(αi, βi), the plot of the above equation as a function of θj is called the Item Characteristic Curve (ICC).

Parameter βi, the item difficulty, indicates the point at which P(i,j)=0.5, which means that the item's difficulty is a property of the item itself, not of the people that responded to the item. Moreover, IRT places βi and θj on the same scale so that they can be compared. If an examinee's ability is higher than the difficulty of the question, then he has higher probability to get the right answer, and vice versa. Parameter αi, the item discrimination, is proportional to the slope of P(i,j)=Pi (θj) at the point where P(i,j)=0.5; the steeper the slope, the higher the discriminatory power of a question, meaning that this question can well differentiate among examinees whose abilities are below and above the difficulty of this question.

In our IRT-based computation of the privacy risk, the probability Prob R(i, j)=1 is estimated using the above equation, using users and profile items. The mapping is such that each examinee is mapped to a user and each question is mapped to a profile item. The ability of an examinee can be used to quantify the attitude of a user: for user j, his attitude θj quantifies how concerned j is about his privacy; low values of θj indicate a conservative user, while high values of θj indicate a careless user. The difficulty parameter βi is used to quantify the sensitivity of profile item i. Items with high sensitivity value βi are more difficult to disclose. In general, parameter βi can take any value within (−1,1). In order to maintain the monotonicity of the privacy risk with respect to items' sensitivity it is guaranteed that βi is greater than or equal to 0 for all I within {1, . . . , n}. This can be handled by shifting all items' sensitivity values by βmin=argminᵢε{1, . . . , n} βi. In the above mapping, parameter αi is ignored.

For computing the privacy risk, the sensitivity βi for all items i in {1, . . . , n} and the probabilities P(i,j)=Prob R(i, j)=1 is computed. For the latter computation, all the parameters ξi=(αi, βi) for 1 less than or equal to i less than or equal to n and θj for 1 less than or equal to j less than or equal to N is determined.

Three independence assumptions are inherent in IRT models: (a) independence between items, (b) independence between users, and (c) independence between users and items. The privacy-risk score computed using these methods is the Pr IRT score.

### IRT-Based Computation of Sensitivity

In computing the sensitivity βi of a particular item i, the value of αi, for the same item, is obtained as a byproduct. Since items are independent, the computation of parameters ξi=(αi, βi) is done separately for every item. Below is shown how to compute ξi assuming that the attitudes of the N individuals ˜θ=(θ₁, . . . , θ_{N}) are given as part of the input. Further shown is the computation of items' parameters when attitudes are not known.

### Item Parameters Estimation

The likelihood function is defined as:

$${\prod }_{j = 1}^{N} {{P}_{ij}^{( i , j )} ( 1 - {P}_{ij} )}^{1 - R ( i , j )}$$

Therefore, ξi=(αi, βi) is estimated in order to maximize the likelihood function. The above likelihood function assumes a different attitude per user. In one embodiment, online social-network users form a grouping that partitions the set of users {1, . . . , N} into K non-overlapping groups {F₁, . . . , F_{K}} such that the union of g=1 to K of Fg={1, . . . , N}. Let θg be the attitude of group Fg (all members of Fg share the same attitude θg) and fg=|Fg|. Also, for each item i, let r_{ig} be the number of people in Fg that set R(i,j)=1, that is, r_{ig}=|{j|j within Fg and R(i, j)=1}|. Given such grouping, the likelihood function can be written as:

$${\prod }_{g = 1}^{K} {{( \begin{matrix}{f}_{g} \\ {r}_{ig}\end{matrix} ) [ {P}_{i} ( {θ}_{g} ) ]}^{{r}_{ig}} [ 1 - {P}_{i} ( {θ}_{g} ) ]}^{{f}_{g} - {r}_{ig}}$$

After ignoring the constants, the corresponding log-likelihood function is:

$$L = {\sum }_{g = 1}^{K} [ {r}_{g} log {P}_{i} ( {θ}_{g} ) + ( {f}_{g} - {r}_{ig} ) log ( 1 - {P}_{i} ( {θ}_{g} ) ) ]$$

Item parameters ξi=(αi, βi) are estimated in order to maximize the log-likelihood function. In one embodiment, the Newton-Raphson method is used. The Newton-Rapshon method is a method that, given partial derivatives:

$${L}_{1} = \frac{\partial L}{\partial {α}_{i}} and {L}_{2} = \frac{\partial L}{\partial {β}_{i}} , and {L}_{11} = \frac{{\partial }^{2} L}{\partial {α}_{i}^{2}} , \\ {L}_{22} = \frac{{\partial }^{2} L}{\partial {β}_{i}^{2}} , {L}_{12} = {L}_{21} \frac{{\partial }^{2} L}{\partial {α}_{i} {β}_{i}}$$

estimates parameters ξi=(αi, βi) iteratively. At iteration (t+1), the estimates of the parameters denoted by

$${[ \begin{matrix}{\hat{α}}_{i} \\ {\hat{β}}_{i}\end{matrix} ]}_{t + 1}$$

are computed from the corresponding estimates at iteration t, as follows:

$${[ \begin{matrix}{\hat{α}}_{i} \\ {\hat{β}}_{i}\end{matrix} ]}_{t + 1} = {[ \begin{matrix}{\hat{α}}_{i} \\ {\hat{β}}_{i}\end{matrix} ]}_{t} - {[ \begin{matrix}{L}_{11} & {L}_{12} \\ {L}_{21} & {L}_{22}\end{matrix} ]}_{t}^{- 1} \times {[ \begin{matrix}{L}_{11} \\ {L}_{21}\end{matrix} ]}_{t}$$

At iteration (t+1), the values of the derivatives L₁, L₂, L₁₁, L₂₂, L₁₂ and L₂₁ are computed using the estimates of αi and βi computed at iteration t.

In one embodiment for computing ξi=(αi, βi) for all items i in {1, . . . , n}, the set of N users with attitudes ˜θ are partitioned into K groups. Partitioning implements an 1-dimensional clustering of users into K clusters based on their attitudes, which may be done optimally using dynamic programming.

The result of this procedure is a grouping of users into K groups {F₁, . . . , F_{K}}, with group attitudes θg, 1 less than or equal to g less than or equal to K. Given this grouping, the values of fg and r_{ig} for 1 less than or equal to i less than or equal to n and 1 less than or equal to g less than or equal to K are computed. Given these values, the Item NR Estimation implements the above equation for each one of the n items.

Algorithm 1 Item-parameter estimation of ξᵢ = (αᵢ,βᵢ) for
all items i ∈ {1,...,n}.

```
  Input: Response matrix R, users attitudes \vec{θ} = (θ₁,...,θ_{N}) and the
  number K of users' attitude groups.
  Output: Item parameters \vec{α} = (α₁,..., α_{N}) and \vec{β} = (β₁,...,β_{N}).
1: {F_{g},θ_{g}}_{g=1}^{K} ← PartitionUsers(θ,K)
2: for g = 1 to K do
3:  f_{g} ← |F_{g}|
4:  for i = 1 to n do
5:  r_{ig} ← |{j|j ∈ F_{g} and R(i,j) = 1}|
6: for i = 1 to n do
7:  (αᵢ,βᵢ) ← NR_Item_Estimation(Rᵢ,{f , r_{ig},θ_{g}}_{g=1}^{K})
```

### The EM Algorithm for Item Parameter Estimation

In one embodiment, the item parameters may be computed without knowing users attitudes, thus only having response matrix R as an input. Let ˜ξ=(ξ₁, . . . , ξn) be the vector of parameters for all items. Hence, ˜ξ is estimated given response matrix R (i.e, ˜ξ that maximizes P(R|˜ξ)). Let ˜θ be hidden and unobserved variables. Thus, P(R|˜ξ)=the summation for ˜θ of P(R,˜θ|˜ξ). Using Expectation-Maximization (EM), ˜ξ is computed for which the above marginal achieves a local maximum by maximizing the expectation function below:

E_{\vec{θ}˜P(\vec{θ}|R,\vec{ξ})}[log P(R,\vec{θ}|\vec{ξ})]

For a grouping of users into K groups:

$$log P ( R , \vec{θ} \vert \vec{ξ} ) = {\sum }_{i = 1}^{n} {\sum }_{g = 1}^{K} [ \begin{matrix}{r}_{g} log {P}_{i} {θ}_{g} + \\ ( {f}_{g} - {r}_{ig} ) log ( 1 - {P}_{i} ( {θ}_{g} ) )\end{matrix} ]$$

Taking the expectation E of this yields:

$$E [ log P ( R , \vec{θ} \vert \vec{ξ} ) ] = {\sum }_{i = 1}^{n} {\sum }_{g = 1}^{K} [ \begin{matrix}E [ {r}_{ig} ] log {P}_{i} ( {θ}_{g} ) + \\ E [ {f}_{ig} - {r}_{ig} ] log ( 1 - {P}_{i} ( {θ}_{g} ) )\end{matrix} ]$$

Using an EM algorithm to maximize the equation, the estimate of the parameter at iteration (t+1) is computed from the estimated parameter at iteration t using the following recursion:

\vec{ξ}^{(t+1)}=argmax_{\vec{ξ}}E_{\vec{θ}˜P(\vec{θ}|R,\vec{ξ}}_{^{(t)}}₎[log P(R,\vec{θ}|\vec{ξ})]

The pseudocode for the EM algorithm is given in Algorithm 2 below. Each iteration of the algorithm consists of an Expectation and a Maximization step.

Algorithm 2 The EM algorithm for estimating item parameters ξᵢ =
(αᵢ,βᵢ,) for all items i ∈ {1,...,n}.

```
  Input: Response matrix R and number K of user groups with the
  same attitudes.
  Output: Item parameters \vec{α} = (α₁,...,αₙ), \vec{β} = (β₁,...,βₙ).
1: for i = 1 to n do
2:  αᵢ ← random_number
3:  βᵢ ← random_number
4:  ξᵢ ← (αᵢ,βᵢ)
5: \vec{ξ} ← (ξ₁,...,ξₙ)
6: repeat
  // Expectation step
7:  for i = 1 to n do
8:  for g = 1 to K do
9:  Sample θ_{g} from P(θ_{g} | R,\vec{ξ})
10:  Compute f̅_{ig} using Equation (9)
11:  Compute r̅_{ig} using Equation (10)
  // Maximization step
12:  for i = 1 to n do
13:  (αᵢ,βᵢ) ← NR_Item_Estimation(Rᵢ,{ f̅_{ig}, r̅_{ig},θ_{g}}_{g=1}^{K})
14:  ξᵢ ← (αᵢ,βᵢ)
15: until convergence
```

For fixed estimates ˜ξ, in the expectation step, ˜θ is sampled from the posterior probability distribution P(θ|R,ξ) and the expectation is computed. First, sampling ˜θ under the assumption of K groups means that for every group gε{1, . . . , K} we can sample attitude θg from distribution P(θg|R,˜ξ). Assuming that the probabilities are known to be computed, the terms E[f_{ig}] and E[r_{ig}] for every item i and group g ε{1, . . . , K} can be computed using the definition of expectation. That is,

$$E [ {f}_{ig} ] = {\overline{f}}_{ig} = {\sum }_{j = 1}^{N} P ( {θ}_{g} \vert {R}^{j} , \vec{ξ} )$$

$$and$$

$$E [ {r}_{ig} ] = {\overline{r}}_{ig} = {\sum }_{j = 1}^{N} P ( {θ}_{g} \vert {R}^{j} , \vec{ξ} ) \times R ( i , j )$$

The membership of a user in a group is probabilistic. That is, every individual belongs to every group with some probability; the sum of these membership probabilities is equal to knowing the values of f_{ig} and r_{ig} for all groups and all items allows evaluation of the expectation equation. In the maximization step, a new ˜ξ that maximizes expectation is computed. Vector ˜ξ is formed by computing the parameters ξi for every item i independently.

The posterior probability of attitudes ˜θ: In order to apply the EM framework, vectors ˜θ are sampled from the posterior probability distribution P(˜θ|R,˜ξ). Although in practice this probability distribution may be unknown, the sampling can still be done. Vector ˜θ consists of the attitude levels of each individual jε{1, . . . , N}. In addition, the assumption of the existence of K groups with attitudes {θg} for g=1 to K exists. Sampling proceeds as follows: for each group g, the ability level θg is sampled and the posterior probability that that any user jε{1, . . . , N} has ability level θj=θg is computed. By the definition of probability, this posterior probability is:

$$P ( {θ}_{j} \vert {R}^{j} , \vec{ξ} ) = \frac{P ( {R}^{j} \vert {θ}_{j} , \vec{ξ} ) g ( {θ}_{j} )}{\int P ( {R}^{j} \vert {θ}_{j} , \vec{ξ} ) g ( {θ}_{j} ) d {θ}_{j}}$$

Function g(θj) is the probability density function of attitudes in the population of users. It is used to model prior knowledge about user attitudes (called the prior distribution of users' attitude). Following standard conventions, the prior distribution is assumed to be the same for all users. In addition, it is assumes that function g is the density function of a normal distribution.

The evaluation of the posterior probability of every attitude θj requires the evaluation of an integral. This problem is overcome as follows: Since the existence of K groups is assumed, only K points X₁, . . . X_{K} are sampled on the ability scale. For each t ε{1, . . . , K}, g(Xt) is computed for the density of the attitude function at attitude value Xt. Then, A(Xt) is set as the area of the rectangle defined by the points (Xt−0.5,0), (Xt+0.5,0), (Xt−0.5, g(Xt)) and (Xt+0.5, g(Xt)). The A(Xt) values are normalized such that the summation from t=A to K of (Xt)=1. In that way, the posterior probabilities of Xt are obtained by the following equation:

$$P ( {X}_{t} \vert {R}^{j} , \vec{ξ} ) = \frac{P ( {R}^{j} \vert {X}_{t} , \vec{ξ} ) A ( {X}_{t} )}{{\sum }_{t = 1}^{K} P ( {R}^{j} \vert {X}_{t} , \vec{ξ} ) A ( {X}_{t} )}$$

### IRT-Based Computation of Visibility

The computation of visibility requires the evaluation of P(i,j)=Prob(R(i,j)=1).

The NR Attitude Estimation algorithm, which is a Newton-Raphson procedure for computing the attitudes of individuals, given the item parameters ˜α=(α₁, . . . , αn) and ˜β=(β₁, . . . , βn), is described. These item parameters could be given as input or they can be computed using the EM algorithm (see Algorithm 2). For each individual j, the NR Attitude Estimation computes θj that maximizes likelihood, defined as the multiplication series from i=1 to n of P(i,j)̂(R(i,j)) (1−P(i,j))̂(1−R(i,j)), or the corresponding log-likelihood, as follows:

$$L = {\sum }_{i = 1}^{n} [ \begin{matrix}R ( i , j ) log {P}_{ij} + \\ ( 1 - R ( i , j ) ) log ( 1 - {P}_{ij} )\end{matrix} ]$$

Since ˜α and ˜β are part of the input, the variable to maximize over is θj. The estimate of θj, denoted by ̂θj, is obtained iteratively using again the Newton-Raphson method. More specifically, the estimate ̂θj at iteration (t+1), [̂θj]ₜ₊₁, is computed using the estimate at iteration t, [̂θj]ₜ, as follows:

$${[ {\hat{θ}}_{j} ]}_{t + 1} = {[ {\hat{θ}}_{j} ]}_{t} - {{[ \frac{{\partial }^{2} L}{\partial {θ}_{j}^{2}} ]}_{t}^{- 1} [ \frac{\partial L}{\partial {θ}_{j}} ]}_{t}$$

### Privacy Risk for Polytomous Settings

The computation of the privacy risk of users when the input is a dichotomous response matrix R has been described. Below, the definitions and methods described in the previous sections are extended to handle polytomous response matrices. In polytomous matrices, every entry R(i,j)=k with kε{0, 1, . . . , l}. The smaller the value of R(i,j), the more conservative the privacy setting of user j with respect to profile item i. the definitions of privacy risk previously given are extended to the polytomous case. Also shown below is how the privacy risk may be computed using Naive and IRT-based approaches.

As in the dichotomous case, the privacy risk of a user j with respect to profile-item i is a function of item i's sensitivity and the visibility item i gets in the social network due to j. In the polytomous case, both sensitivity and visibility depend on the item itself and the privacy level k assigned to it. Therefore, the sensitivity of an item with respect to a privacy level k is defined as follows.

Definition 3: The sensitivity of item iε{1, . . . , n} with respect to privacy level k ε{0, . . . , l}, is denoted by βᵢₖ. Function βᵢₖ is monotonically increasing with respect to k; the larger the privacy level k picked for item i the higher its sensitivity.

The relevance of Definition 3 is seen in the following example.

### Example 5

Assume user j and profile item i={mobile-phone number}. Setting R(i,j)=3 makes item i more sensitive than setting R(i,j)=1. In the former case i is disclosed to many more users and thus there are more ways it can be misused.

Similarly, the visibility of an item becomes a function of its privacy level. Therefore, Definition 2 can be extended as follows.

Definition 4: If P_{i,j,k}=Prob {R(i,j)=k}, then the visibility at level k is V(i,j,k)=P_{i,j,k}×k.

Given Definitions 3 and 4, the privacy risk of user j is computed as:

$${P}_{R} ( j ) = {\sum }_{i = 1}^{n} {\sum }_{k = 1}^{t} {β}_{ik} \times {P}_{ijk} \times k$$

The Naïve Approach to Computing Privacy Risk for Polytomous Settings

In the polytomous case, the sensitivity of an item is computed for each level k separately. Therefore, the Naive computation of sensitivity is the following:

$${β}_{ik} = \frac{N - {\sum }_{j = 1}^{N} {I}_{( R ( i , j ) = k )}}{N}$$

The visibility in the polytomous case requires the computation of probability P_{i,j,k}=Prob{R(i,j)=k}. By assuming independence between items and users, this probability can be computed as follows:

$$\begin{matrix}{P}_{ijk} = \frac{{\sum }_{j = 1}^{N} {I}_{( R ( i , j ) = k )}}{N} \times \frac{{\sum }_{i = 1}^{n} {I}_{( R ( i , j ) = k )}}{n} \\ = ( 1 - {β}_{ik} ) \times \frac{{\sum }_{i = 1}^{n} {I}_{( R ( i , j ) = k )}}{n}\end{matrix}$$

The probability Pᵢⱼₖ is the product of the probability of value k to be observed in row i times the probability of value k to be observed in column j. As in the dichotomous case, the score computed using the above equations is the Pr Naive score.

### IRT-Based Approach to Determine Privacy Risk Score for Polytomous Settings

Handling a polytomous response matrix is slightly more complicated for the IRT-based privacy risk. Computing the privacy risk is a transformation of the polytomous response matrix R into (l+1) dichotomous response matrices R*₀, R*₁, . . . , R*ₗ. Each matrix R*ₖ (for kε{0, 1, . . . , l}) is constructed so that R*ₖ(i,j)=1 if R(i,j)≧k, and R*ₖ(i,j)=0 otherwise. Let P*ᵢⱼₖ=Prob{R(i,j)≧k}. Since matrix R*ᵢ₀ has all its entries equal to one, Pᵢⱼ₀=1 for all users. For other dichotomous response matrix R*ₖ with kε{1, . . . , l} the probability of setting R*ₖ(i,j)=1 is given as:

$${P}_{ijk}^{*} = \frac{1}{1 + {e}^{- {α}_{ik}^{*} ( {θ}_{j} - {β}_{ik}^{*} )}}$$

By construction, for every k′, kε{1, . . . , l} and k′<k, matrix R*ₖ contains only a subset of the 1-entries appearing in matrix R*ₖ′. Therefore, P*ᵢⱼₖ′≧Pᵢⱼₖ. Hence, ICC curves of P*ᵢⱼₖ for kε{1, . . . , l} do not cross. This observation results in the following corollary:

Corollary 1: For items i and privacy levels kε{1, . . . , l}, β*i₁< . . . <β*iₖ< . . . <β*iₗ. Moreover, since curves Pᵢⱼₖ do not cross, α*ᵢ₁= . . . =α*ᵢₖ= . . . =α*ᵢ₁=α*ᵢ.

Since Pᵢⱼ₀=1, α*ᵢ₀ and β*ᵢ₀ are not defined.

The computation of privacy risk may require computing Pᵢⱼₖ=Prob {R(i,j)=k}. This probability is different from P*ᵢⱼₖ since the former refers to the probability of entry R(i,j)=k, while the latter is the cumulative probability P*ᵢⱼₖ=the summation from k′=k to l of Pᵢⱼₖ. Alternatively:

Prob{R(i,j)=k}=Prob{[Rₖ*(i,j)−Rₖ₊₁*(i,j)]}

The above equation may be generalized to the following relationship between P*ᵢₖ and Pᵢₖ: for every item i, attitude θj and privacy level kε{0, . . . , l−1},

Pᵢₖ(θⱼ)=Pᵢₖ*(θⱼ)−Pᵢ₍ₖ₊₁₎*(θⱼ)

For k=l, Pᵢₗ(θj)=P*ᵢₗ(θj).

Proposition 1: For kε={1, . . . , l−1}, (β*ᵢₖ+β*ᵢ₍ₖ₊₁₎)/2. Also, βᵢ₀=β*ᵢ₁ and βᵢₗ=β*ᵢₗ.

From Proposition 1 and Corollary 1 provides Corollary 2:

Corollary 2. For kε={1, . . . , l}, βᵢ₀<βᵢ₁< . . . <βᵢₗ.

IRT-based sensitivity for polytomous settings: The sensitivity of item i with respect to privacy level k, βᵢₖ, is the sensitivity parameter of the Pᵢⱼₖ curve. It is computed by first computing the sensitivity parameters β*ᵢₖ and β*₁₍ₖ₊₁₎. Then Proposition 1 is used to compute βᵢₖ.

The goal is to compute the sensitivity parameters β*ᵢ₁, . . . , β*ᵢ₁ for each item i. Two cases are considered: one where the users' attitudes ˜θ are given as part of the along with the response matrix R, and the case where the input consists of only R. In referring to the second case, all (l+1) unknown parameters α*ᵢ and β*ᵢₖ for 1≦k≦l are computed simultaneously. Assume that the set of N individuals can be partitioned into K groups, such that all the individuals in the g-th group have the same attitude θg. Also, let Pᵢₖ(θg) be the probability that an individual j in group g sets R(i,j)=k. Finally, denote by f_{g} the total number of users in the g-th group and by r_{gk} the number of people in g-th group that set R(i,j)=k. Given this grouping, the likelihood of the data in the polytomous case can be written as:

$${\prod }_{g = 1}^{K} \frac{{f}_{j} !}{{r}_{g 1} ! {r}_{g 2} ! … {r}_{g l} !} {\prod }_{k = 1}^{l} {[ {P}_{ik} ( {θ}_{g} ) ]}^{{r}_{gk}}$$

After ignoring the constants, the corresponding log-likelihood function is:

$$L = {\sum }_{g = 1}^{K} {\sum }_{k = 1}^{l} {r}_{gk} log {P}_{ik} ( {θ}_{g} )$$

Using subtraction for the last three equations, L may be transformed into a function where the only unknowns are the (l+1) parameters (α*ᵢ, β*ᵢ₁, . . . , β*ᵢₗ). The computation of these parameters is done using an iterative Newton-Raphson procedure, similar as to previously described, except the difference here is that there are more unknown parameters for which to compute the partial derivatives of log-likelihood L.

IRT-based visibility for polytomous settings: Computing the visibility values in the polytomous case requires the computation of the attitudes ˜θ for all individuals. Given the item parameters α*₁, β*ᵢ₁, . . . , β*ᵢₗ, computation may be done independently for each user, using a procedure similar to NR Attitude Estimation. The difference is that the likelihood function used for the computation is the one given in the previous equation.

The IRT-based computations of sensitivity and visibility for polytomous response matrices give a privacy-risk score for every user. As in the dichotomous IRT computations, the score thus obtained is referred to as the Pr IRT score.

### Exemplary Computer Architecture for Implementation of Systems and Methods

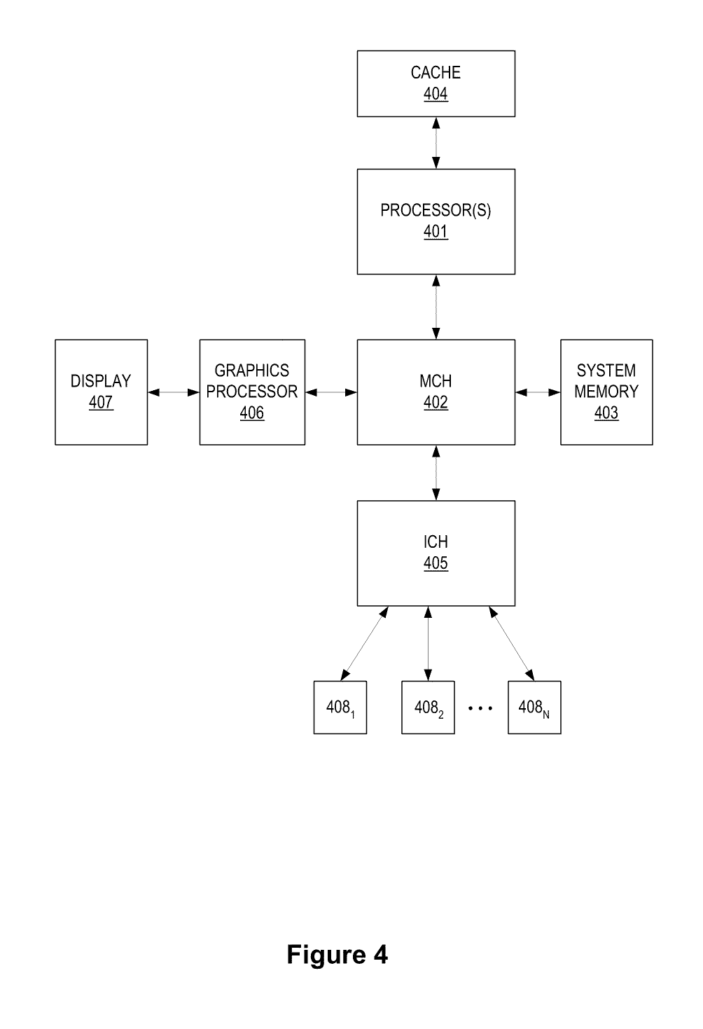

FIG. 4 illustrates an example computer architecture for implementing a computing of privacy settings and/or a privacy environment. In one embodiment, the computer architecture is an example of the console 205 in FIG. 2. The exemplary computing system of FIG. 4 includes: 1) one or more processors 401; 2) a memory control hub (MCH) 402; 3) a system memory 403 (of which different types exist such as DDR RAM, EDO RAM, etc,); 4) a cache 404; 5) an I/O control hub (ICH) 405; 6) a graphics processor 406; 7) a display/screen 407 (of which different types exist such as Cathode Ray Tube (CRT), Thin Film Transistor (TFT), Liquid Crystal Display (LCD), DPL, etc.); and/or 8) one or more I/O devices 408.

The one or more processors 401 execute instructions in order to perform whatever software routines the computing system implements. For example, the processors 401 may perform the operations of determining and translating indicators or determining a privacy risk score. The instructions frequently involve some sort of operation performed upon data. Both data and instructions are stored in system memory 403 and cache 404. Data may include indicators. Cache 404 is typically designed to have shorter latency times than system memory 403. For example, cache 404 might be integrated onto the same silicon chip(s) as the processor(s) and/or constructed with faster SRAM cells whilst system memory 403 might be constructed with slower DRAM cells. By tending to store more frequently used instructions and data in the cache 404 as opposed to the system memory 403, the overall performance efficiency of the computing system improves.

System memory 403 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 403 prior to their being operated upon by the one or more processor(s) 401 in the implementation of a software program. Similarly, data that a software program determines should be sent from the computing system to an outside entity through one of the computing system interfaces, or stored into an internal storage element, is often temporarily queued in system memory 403 prior to its being transmitted or stored.

The ICH 405 is responsible for ensuring that such data is properly passed between the system memory 403 and its appropriate corresponding computing system interface (and internal storage device if the computing system is so designed). The MCH 402 is responsible for managing the various contending requests for system memory 403 access amongst the processor(s) 401, interfaces and internal storage elements that may proximately arise in time with respect to one another.

One or more I/O devices 408 are also implemented in a typical computing system. I/O devices generally are responsible for transferring data to and/or from the computing system (e.g., a networking adapter); or, for large scale non-volatile storage within the computing system (e.g., hard disk drive). ICH 405 has bi-directional point-to-point links between itself and the observed I/O devices 408. In one embodiment, I/O devices send and receive information from the social networking sites in order to determine privacy settings for a user.

Modules of the different embodiments of a claimed system may include software, hardware, firmware, or any combination thereof. The modules may be software programs available to the public or special or general purpose processors running proprietary or public software. The software may also be specialized programs written specifically for signature creation and organization and recompilation management. For example, storage of the system may include, but is not limited to, hardware (such as floppy diskettes, optical disks, CD-ROMs, and magneto-optical disks, ROMs, RAMs, EPROMs, EEPROMs, flash, magnetic or optical cards, propagation media or other type of media/machine-readable medium), software (such as instructions to require storage of information on a hardware storage unit, or any combination thereof.

In addition, elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, flash, magnetic or optical cards, propagation media or other type of media/machine-readable medium suitable for storing electronic instructions.

For the exemplary methods illustrated in Figures . . . , embodiments of the invention may include the various processes as set forth above. The processes may be embodied in machine-executable instructions which cause a general-purpose or special-purpose processor to perform certain steps. Alternatively, these processes may be performed by specific hardware components that contain hardwired logic for performing the processes, or by any combination of programmed computer components and custom hardware components.

Embodiments of the invention do not require all of the various processes presented, and it may be conceived by one skilled in the art as to how to practice the embodiments of the invention without specific processes presented or with extra processes not presented.

### General

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention. For example, while it has been described to propagate privacy settings within or among social networks, propagation of settings may occur between devices, such as two computers sharing privacy settings.

What is claimed is:

1. A computer-implemented method for managing security and/or privacy settings, comprising:
communicably coupling a first client to a second client;
propagating a portion of a plurality of security and/or privacy settings for the first client from the first client to the second client; and
upon receiving at the second client the portion of the plurality of security and/or privacy settings for the first client, incorporating the received portion of the plurality of security and/or privacy settings for the first client into a plurality of security and/or privacy settings for the second client.

2. The computer-implemented method of claim 1, wherein the first client and the second client are profiles on a social network.

3. The computer-implemented method of claim 1, wherein:
the first client is a profile on a first social network; and
the second client is a profile on a second social network.

4. The computer-implemented method of claim 1, further comprising:
comparing the plurality of security and/or privacy settings for the first client to the plurality of security and/or privacy settings for the second client; and
determining from the comparison the portion of the plurality of security and/or privacy settings to be propagated to the second client.

5. The computer-implemented method of claim 1, further comprising:
communicably coupling a plurality of clients with the second client;
comparing the plurality of security and/or privacy settings for the second client to a plurality of security and/or privacy settings for each of the plurality of clients;
determining from the comparison which security and/or privacy settings for the plurality of clients are to be incorporated into the plurality of security and/or privacy settings for the second client;
propagating to the second client the security and/or privacy settings to be incorporated; and
upon receiving at the second client the security and/or privacy settings to be incorporated, incorporating the received security and/or privacy settings into the plurality of security and/or privacy settings for the second client.

6. The computer-implemented method of claim 5, wherein the plurality of clients and the second client are a plurality of profiles on a social network that form a social graph for the second client.

7. The computer-implemented method of claim 6, wherein comparing the plurality of security and/or privacy settings comprises computing a privacy risk score of a first client.

8. A system for managing security and/or privacy settings, comprising:
a coupling module configured to communicably couple a first client to a second client;
a propagation module configured to propagate a portion of a plurality of security and/or privacy settings for the first client from the first client to the second client; and
an integration module configured to incorporate the received portion of the plurality of security and/or privacy settings for the first client into a plurality of security and/or privacy settings for the second client upon receiving at the second client the portion of security and/or privacy settings from the first client.

9. The system of claim 8, wherein the first client and the second client are profiles on a social network.

10. The system of claim 8, wherein:
the first client is a profile on a first social network; and
the second client is a profile on a second social network.

11. The system of claim 8, further comprising a comparison module configured to:
compare the plurality of security and/or privacy settings for the first client to the plurality of security and/or privacy settings for the second client; and
determine from the comparison the portion of the plurality of security and/or privacy settings for the first client to be propagated to the second client.

12. The system of claim 8, wherein:
the coupling module is further configured to communicably couple a plurality of clients with the second client;
the comparison module is further configured to:
compare the plurality of security and/or privacy settings for the second client to a plurality of security and/or privacy settings for each of the plurality of clients; and
determine from the comparison which security and/or privacy settings for the plurality of clients are to be incorporated into the plurality of security and/or privacy settings for the second client;
the propagation module is further configured to propagate to the second client the security and/or privacy settings to be incorporated into the plurality of security and/or privacy settings for the second client; and
the integration module is further configured to incorporate the received security and/or privacy settings into the plurality of security and/or privacy settings for the second client upon receiving at the second client the security and/or privacy settings to be incorporated.

13. The system of claim 12, wherein the plurality of clients and the second client are a plurality of profiles on a social network that form a social graph for the second client.

14. The system of claim 13, wherein a privacy risk score is computed for a first client during comparison of the plurality of security and/or privacy settings.

15. A computer program product comprising a computer useable storage medium to store a computer readable program, wherein the computer readable program, when executed on a computer, causes the computer to perform operations comprising:
communicably coupling a first client to a second client;
propagating a portion of a plurality of security and/or privacy settings for the first client from the first client to the second client; and
upon receiving at the second client the portion of the plurality of security and/or privacy settings for the first client, incorporating the received portion of the plurality of security and/or privacy settings for the first client into a plurality of security and/or privacy settings for the second client.

16. The computer program product of claim 15, wherein the first client and the second client are profiles on a social network.

17. The computer program product of claim 15, wherein:
the first client is a profile on a first social network; and
the second client is a profile on a second social network.

18. The computer program product of claim 15, wherein the computer readable program causes the computer to perform operations further comprising:
comparing the plurality of security and/or privacy settings for the first client to the plurality of security and/or privacy settings for the second client; and
determining from the comparison the portion of the plurality of security and/or privacy settings to be propagated to the second client.

19. The computer program product of claim 15, wherein the computer readable program causes the computer to perform operations further comprising:
communicably coupling a plurality of clients with the second client;
comparing the plurality of security and/or privacy settings for the second client to a plurality of security and/or privacy settings for each of the plurality of clients;
determining from the comparison which security and/or privacy settings for the plurality of clients are to be incorporated into the plurality of security and/or privacy settings for the second client;
propagating to the second client the security and/or privacy settings to be incorporated; and
upon receiving at the second client the security and/or privacy settings to be incorporated, incorporating the received security and/or privacy settings into the plurality of security and/or privacy settings for the second client.

20. The computer program product of claim 19, wherein the plurality of clients and the second client are a plurality of profiles on a social network that form a social graph for the second client.
